(19) United States
(12) Patent Application Publication
(10) Pub. No.: US 2007/0226063 A1
(43) Pub. Date: Sep. 27, 2007

(54) REAL-TIME SUBJECTIVE AND DEMOGRAPHIC VENUE EVALUATION METHOD

(76) Inventor: Michael F. Hanson, Smyrna, GA (US)

Correspondence Address: STEVEN L. SCHMID, 1824 HICKORY TRACE DRIVE, FLEMING ISLAND, FL, 32003, US

(21) Appl. No.: 11/678,058

(22) Filed: Feb. 22, 2007

Related U.S. Application Data
(60) Provisional application No. 60/786,289, filed on Mar. 27, 2006.

(51) Int. Cl. G06Q 30/00

(52) U.S. Cl. 705/15

(57) ABSTRACT

Disclosed is a method for providing a real-time evaluation of venues such as clubs, bars and restaurants. The real-time evaluation provides a user member with an instantaneous snapshot of a venue's happenings. The method evaluates a venue based upon both subjective and demographic criteria. Subjective criteria provide an understanding of the feeling or mood associated with a venue. Demographic criteria provide information on who is attending a venue. The method provides a real-time impression or view of the ever-changing happenings in a venue.

### RELATED APPLICATION

This application relies upon U.S. Provisional Application Ser. No. 60/786,289, filed Mar. 27, 2006, the content of which is hereby incorporated in its entirety.

### TECHNICAL FIELD

The present method relates to a system for providing an evaluation of a venue and in greater detail the present method includes a real-time evaluation of a venue providing users with both relevant subjective and objective criteria for evaluating same.

### BACKGROUND

Guides to aid a consumer in choosing a proper venue have been around for over a century. For example, the famed Michelin Guide was first published in 1900 to aid French motorists in finding acceptable lodging and desirable restaurants. Today a three star rating by the Michelin Guide, signifying exceptional cuisine worthy of a special journey, ensures a restaurant's success.

However, the Michelin Guide is only published annually and provides a once a year snapshot of a venue. Unfortunately, venues change over time and a restaurant that was at the beginning of the year a three star may not be so six months down the line as evidenced by the changing ratings given by Michelin from year to year. Moreover, a customer may be paying for a three star restaurant but may be only eating a two star meal. Additional examples of such restaurant review services having similar limitations as the Michelin Guide include Fodor's and Zagat.

In an effort to provide a more update review of venues some have turned to internet enabled guides which do not depend upon a paper copy publication and can be updated without reprinting the entire guide. For example, Citysearch.com provides reviews of various venues online for select cites. The reviews in Citysearch include editorial reviews and reviews by users. User reviews may be from just a few days old to those written over the past few months or more. Citysearch is unable to provide real-time review of a venue which would be helpful in determining if a bar or club is worth visiting for an evening or a particular restaurant had an excellent special for any particular night.

Venues are also made desirable by the people attending a particular venue. Friends often make a venue a desirable place to visit when they are in attendance. Additionally, the type of patrons visiting a venue on any particular day or night also make a venue more desirable over another. A club's atmosphere and ambiance can change both nightly and hourly.

Accordingly, it would be advantageous to provide a method and system for providing a real-time evaluation of a venue to aid one in determining if a venue is desirable for attending that day or evening.

### SUMMARY

The present invention comprises both a method and system for providing a real-time evaluation of venues such as clubs, bars and restaurants. The real-time evaluation provides a member user with an instantaneous snapshot of a venue's happenings. The method evaluates a venue based upon both subjective and demographic criteria. Subjective criteria provide an understanding of the feeling or mood associated with a venue. Demographic criteria or analysis provides information on who is attending a venue. The present method provides a real-time impression or view of the ever-changing happenings in a venue.

In greater detail, the method for evaluating a venue includes providing to a member user in real-time venue information over an electronic network. Venue information includes both a real-time subjective critical review of the venue and a real-time demographic analysis of member users attending the venue. The subjective critical review includes the ambiance factors of the venue which may be compiled and submitted by member users attending the venue in real-time. The demographical analysis includes statistical information regarding the demographic makeup of member users attending the venue. Additionally, the method may graphically display both venue and user locations as coordinates on a map.

In a further embodiment, the method includes an encyclopedic database editable by member users for evaluating a venue. Furthermore, the member user may provide a set of desired demographic criteria by which to further evaluate the venue based upon user members attending a venue matching the desired demographic criteria. The venue may also be evaluated by determining the user members who have registered an intention of attending the venue.

An additional embodiment of the present method includes providing to a member user over an electronic network, venue information in real-time, wherein the popularity of the venue is graphically displayed on a map. The popularity of a venue may be represented by glowing bars, wherein more bars represent the increasing popularity of a venue. The method may further include a user alert list comprised of members having a select member demographic profile of compatibility and notifying a member user over the network if another user within the user alert list is in close physical proximity. Additionally, the method may include broadcasting messages between members over an electronic network.

A further embodiment of the present method for evaluating a venue includes providing to a member user over an electronic network in real-time a set of information regarding a venue. The provided venue information includes a real-time subjective critical review of the venue including ambiance factors which may be comprised in part of a subjective review by the nonmember patrons attending the venue.

Venue information also includes a real-time demographical analysis comprised of statistical information regarding the demographic makeup of member users attending the venue. The method may also include an encyclopedic database editable by users for evaluating a venue and a graphic display for showing venue and user locations as coordinates on a map.

### DRAWINGS

In the drawings:

FIG. 1 depicts the member user requesting a venue evaluation from a central server wherein the method application resides, and the server application providing venue information to the member user and a member user patron providing a subjective review of the venue to the server application;

FIG. 2 is a block flow diagram illustrating the present method wherein a request for a venue evaluation is made to the server and the server processes the request by providing venue information comprised of a demographical analysis and a subjective critical review to the member user; and

FIG. 3 illustrates a flag icon appearing above and connect to a venue icon, wherein the flag icon contains a first portion having bar section having lighted squares which may indicate the level of interest in a venue and a second portion providing further venue information.

### DETAILED DESCRIPTION

The present invention comprises both a method and system for providing a real-time evaluation of one or more venues. A venue may be any location or scene where people may congregate for any action or event. Typically, venues include clubs, bars and restaurants, but may also include, without limitation, such events as house parties, family reunions, concerts, town meetings, county fairs, and other informal gatherings. The real-time evaluation function of the present invention provides an instantaneous snapshot of a venue's happenings.

A venue is evaluated based upon both subjective and demographic criteria. Subjective criteria is used to evaluate a venue's ambiance and the demographic criteria informs a member on who is attending a venue. The present method provides a real-time impression of the ever changing happenings in a venue.

The present method for evaluating a venue includes providing to a member user in real-time over an electronic network certain venue information useful for evaluating a venue. A member user is an authorized user of the present method who has taken some step to register a demographic profile of the member user within the present method. The profile may be stored on a central server. Demographic information provided by the member user may include, by way of example, without limitation, the age, gender, schooling, marital status, political party affiliations, school affiliations, team affiliations, club affiliations, organizational affiliations, hobbies, interests, profession, sexual orientation, annual income, sporting team preferences, relationship status, musical preferences, entertainment preferences, and food preferences of the member user.

Real-time presentation of venue information provides a snapshot of the venue's happenings or atmosphere for a contemporaneously planned outing. The term “real-time” is defined herein in one embodiment to include information not more than three (3) hours old being provided to a member user. Information is more than three (3) hours old if that information comprises a report of events that have occurred more than three (3) hours prior to the member user requesting the venue information.

The electronic network over which the venue information is provided to the member user may be any known electronic network utilized to transmit data from point to point. By way of example, but not limitation, the electronic network may comprise a cellular phone system, wireless internet, and wired networks. Devices for communicating over such networks include by way of example cellular phone, PDAs, and other computing devices.

The venue information provided over the electronic network comprises both a subjective critical review of the venue and a demographical analysis of the members present at a particular venue. The subjective criteria can be compiled and submitted by member users attending the venue in real-time. The subjective criteria of the critical review includes the ambiance factors of a venue. Ambiance factors include the components that go into making up the feeling or mood associated with a venue. For example, ambiance factors may include the type of crowd including the attractiveness of attendees, ratio of the sexes and quality of music and/or food including the type of music being played. Subjective criteria may also include observable demographic criteria of nonmember users attending a venue.

Demographic criteria include a demographic analysis of member users attending the venue. Member users can be tracked and located using, by way of example, such means as global positioning satellites (GPS) or via cell phone triangulation. Member users located at a venue are noted and tabulated along with their respective registered demographics and the information is processed and presented to the member user as a demographic analysis of the venue.

In a further embodiment, the present method may include a highlighted area of a map graphically represented on a user interface. The highlighted area may appear as a glowing portion on a map graphically presented to the member user. The intensity of the highlighted area or glowing portion of the map indicates the interest in a venue. Interest can be defined using various criteria as determined by the member user. For example, interest may simply be defined as the number of people congregating in an area. Typically, the highlighted area represents a collection of venues. For example, the highlighted area may represent a popular local in a city having a collection of bars or nightclubs. As the member user focuses the graphic interface onto a particular area the glow of the highlighted area becomes less diffuse and more specific. Member users may guide themselves to the most popular places having the greatest interest by following the more intense glowing areas.

The method may graphically display both venue and user locations as coordinates on a map. The graphic display may be enabled though a web enabled application featuring a map graphically representing either as a virtual three-dimensional (artistically rendered) map, a satellite photograph (or collection of satellite photographs), or an overlay of the two. The map may consist of a simple graphical user interface (GUI) consisting only of the map and a search bar. Search results may be displayed through a separate frame anchored to a side of the GUI.

The web enabled application may permit data entry and search functionality, including entry and searching of interests, member data, venue data, member status, venue status, member intentions, and interests specific to certain geographic locations.

Registration enables a user to view the map and to download the mobile application to their mobile device. Registration may require identity validation sufficient to ensure that one individual cannot register multiple times. This can be accomplished through confirmation of credit card, address and e-mail information. Upon registration, members may enter certain demographic criteria and may search for specific venues to view a venue's popularity, zoom in on the map to view cities, and/or specific addresses. Members may search for other members with certain similar demographic characteristics and avail themselves to various function of the mobile application.

When zoomed to an appropriate local level, clickable flags or icons may appear over venues. The flag icon may be anchored to a venue. Once clicked, flags or other graphic icons open to display certain information, including the current popularity of the venue based on current attendance, a description, and current contents regarding the status of the venue. A rating bar with 10 levels may depict the interest in an area or venue graphically. As more members attend a certain venue, the number of glowing bars will increase proportionally to a maximum of 10 glowing bars.

In one embodiment, the flag icon may appear over all venues. The first portion of the flag includes the glowing bar, which is broken down in one embodiment into squares from green to yellow to red from left to right. Lighted squares may indicate the level of interest/popularity/attendance of a venue. The remaining portion of the flag has venue/event identifying criteria and will expand depending on where the curser is placed. Once expanded, member users can see venue driven criteria such as special events and click on the information to get additional information through an external site or pop-up window. Attendance may be proved using the mobile application and the map/location application.

The description available for viewing on the flag may contain the name of the venue, its address, the phone number, a link to the web site, and a wiki style description. Members can participate in the modification of the wiki style description. The web application may also integrate with existing informational databases.

The current comments section of the description may include comments regarding the current status of the venue, including such information as the current attendance, quality of the food/drink and the like. Such comments can be entered via either web application or web site, or entered and submitted from the mobile application. The comments in one embodiment may be displayed in a scrolling marquee like display similar to that of the New York Times facade in Times Square.

The web application can provide a means for providing feedback to the system as to the member's current status, intentions to change status, or the current status of a venue. Such a feedback loop can include a web application into which a member can enter such information, as well as a means for the user member to post such information from their mobile device. In this way, the web application can be assured of providing accurate and timely information about both venues and member demographics.

Members may search the basic profiles of other members based on the demographic data entered at registration and select possible interest. Member users can send a message to the other member requesting approval to be on the member's interest alert list. If approval is received, and the members come in close physical proximity (proximity defined by the user), both of the parties can be alerted with either a text message, or an email. The method can also suggest possible interests based on venue attendance history, or other factors.

The method may contain a demographic matching algorithm. The algorithm may use a point system whereby a point value can be assigned to each comparable attribute. Points can be based on the determined value of an attribute, for example a pub or club designation or preference may be worth 2 points, while a favorite movie might be worth 5 points. A member can choose to search the member database of the method for potential interests. Matching demographic attributes can accumulate points for a total. When a certain threshold is met, an interest is created on the member's interest list. Members can select from a list of potential interests and send messages including their own user profile and a message.

The algorithm can be executed by the method for members within a user defined geographical radius. The method may support the use of broadcast notifications and messaging between members. Members may accumulate points by participating in the method. The points can be used to calculate a member's popularity which may be used to award prizes or other rewards for participation. The method may further generate revenue through the use of advertisement and/or registration fees from member users. Member users may also be awarded points for any manual feedback given. Such points may be awarded to encourage users to provide such feedback.

The mobile application may be comprised of a user interface (UI) consisting of a map locating the device within a member defined radius, the interest produced by other members within that member defined radius, and the venues contained within the member defined radius. The mobile application UI may be divided into sections. One section may contain a map of the current location within a member defined radius. The mobile application may communicate the device's current location to a central server application. The mobile application can prove the location of the device, using such methods as GPS information, cell triangulation, or the PlaceLab project which is a location technology that triangulates the user's location using GSM, Wi-Fi and Bluetooth. The mobile application may provide a bird's eye view, and turn-by-turn directions via the location/mapping application to selected venues or addresses provided.

A second section of the UI includes an interface, which, when selected, will switch the users from the map to an options page. The options page may present the member user with feedback options and a free form text box. If the member user selects feedback they will be able to send information to the method application concerning their status, including any potential status change, the venue's status, and/or comments. The free form text box will allow entry of addresses or venue names and will respond with directions and the current status of the venue.

Within the user interface map, any visible venue on the map can be selected. If a venue is selected, the basic description flag containing the same information as available on the web application may appear. If another member's icon is selected, a dialog page may appear allowing the member user to view, with permission by the selected member, the mobile profile of that selected member. The member user may also elect to send the selected member his or her own mobile profile instantly. If a mobile profile is received, the selected member can elect to respond and communicate immediately with the other member user, or to add that member to their friends list, or both.

Member users may be able to select, from the live screen, whether they are on the grid or off the grid. On the grid means that other member users will be able to see them represented as an icon on their mobile applications, and will be able to communicate with the. Member users that are off the grid are invisible to other member users and such off grid member will not be able to see or communicate with other members users.

Member users may have one or more “friends” lists. Each “friends” list may have a different label, allowing friends to be kept in different lists. A friends list can be a subset of another friends list. Friends may be represented with icons of different colors on the maps. Members may be able to send messages to all friends, or to friends within their user defined proximity, or to friends on a specific friends list. Members may be able to select friends for the ability to be alerted if the friend enters their user defined geographic radius. Members will automatically be alerted if someone on their interests or “friends” list enters their user defined geographic radius.

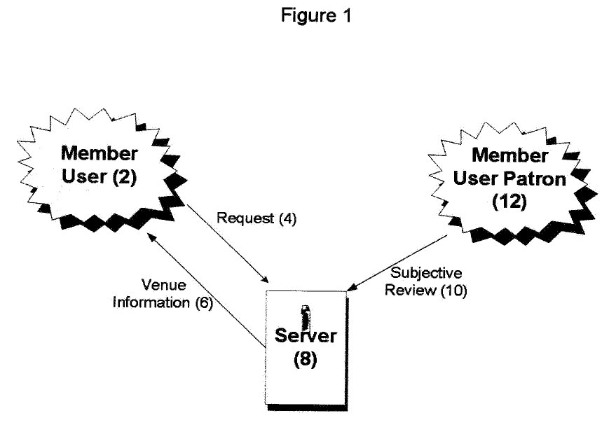

Referring now to the drawings in which like numerals indicate like elements throughout the several views, FIGS. 1-3 depict the present method for providing a real-time evaluation of venues.

As indicated in FIG. 1, the present method includes the member user 2 requesting 4 a venue evaluation from the central server 8 wherein the method application resides. The server 8 and residing application provide venue information 6 to the member user 2. Additionally shown is a member user patron 12 providing a subjective review 10 of the venue to the server 8 which can be processed by the application residing therein to aid in providing real-time venue information 6 to the member user 2.

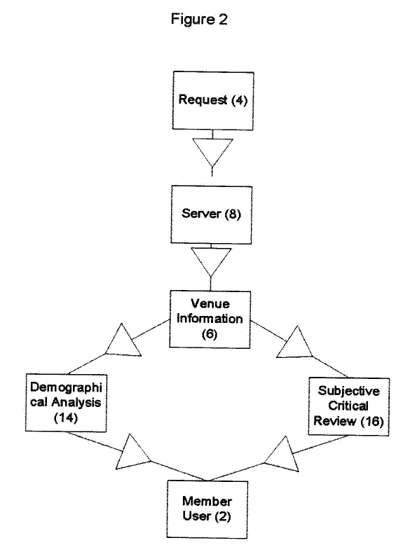

FIG. 2 illustrates a block flow diagram of the present method of providing a real-time evaluation of a venue comprising a request 4 for information to a central server 8. It is however contemplated that the present method may be embodied in various locations and not limited to being embodied in a physical server. For example, information and processing may be accomplished via a plurality machines instead of a central server. Furthermore the term “server” is only used to illustrate a processing core for accumulating and organizing information for distribution and storage and is in no way to be construed as limiting the present method to a particular hardware configuration. For instance, it is contemplated that the present method may be facilitated over a peer to peer network.

Further illustrated in FIG. 2 is the server 8 processing the request 4 and generating venue information 6. The venue information 6 is comprised of a first and second component. The first component is a demographical analysis 14 of the member user patrons 12 residing within a venue of interest. The second component is a subjective critical review 16 of the venue. The subjective critical review 16 is provided in real-time by member user patrons 12. The components of the venue information 6 are provided to a member user 2.

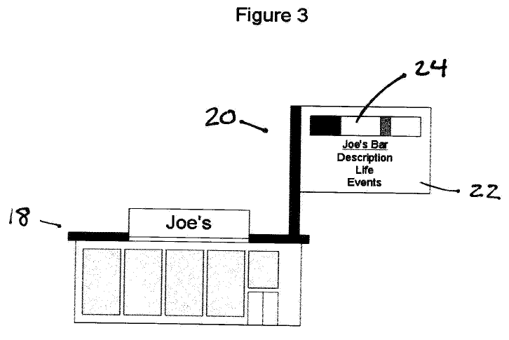

FIG. 3 depicts a flag icon 20 appearing above and connect to a venue icon 18. The flag icon 20 contains a first portion 24 having bar section having lighted squares indicating the level of interest in a venue. The flag icon 20 comprises a second portion 22 providing further venue information.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A method of venue evaluation, comprising:
providing to a member user in real-time, over an electronic network, a venue information, wherein the venue information includes both a real-time subjective critical review of the venue and a real-time demographic analysis of member users attending the venue.

2. The method of claim 1, wherein the subjective critical review is compiled and submitted by member users attending the venue in real-time.

3. The method of claim 2, wherein the subjective critical review comprises ambiance factors.

4. The method of claim 3, wherein the ambiance factors include a subjective review of the nonmember patrons attending the venue.

5. The method of claim 1, further including providing to the member user an encyclopedic database editable by member users evaluating the venue.

6. The method of claim 1, wherein the demographical analysis includes statistical information regarding the demographic makeup of member users attending the venue.

7. The method of claim 6, wherein the demographic makeup of member users includes at least one demographic selected from the group consisting of age, gender, schooling, marital status, political party affiliations, school affiliations, team affiliations, club affiliations, organizational affiliations, hobbies, interests, profession, sexual orientation, annual income, sporting team preferences, relationship status, musical preferences, entertainment preferences, food preferences and combinations thereof.

8. The method of claim 1, further including graphically displaying venue and user locations as location coordinates on a map.

9. The method of claim 1, further including the user member providing a set of desired demographic criteria by which to further evaluate the venue based upon user members attending a venue matching the desired demographic criteria.

10. The method of claim 1, further including evaluating the venue by the user members who have registered an intention of attending the venue.

11. A method of venue evaluation, comprising:
providing to a member user in real-time, over an electronic network, a venue information,
wherein the venue information includes both a real-time subjective critical review of the venue including ambiance factors comprised of a subjective review of the nonmember patrons attending the venue, and
a real-time demographical analysis includes statistical information regarding the demographic makeup of member users attending the venue; and
graphically displaying venue and member user locations as location coordinates on a map.

12. The method of claim 11, wherein a popularity of the venue is further graphically displayed on the map.

13. The method of claim 12, wherein the popularity is represented by glowing bars, wherein more bars represent increasing popularity of a venue.

14. The method of claim 11, further including assembling a user alert list, wherein the user alert list comprises a list of user members having a select member demographic profile of compatibility.

15. The method of claim 14, wherein a user member is notified over a network if another user within the user alert list is in close physical proximity.

16. The method of claim 11, further including broadcasting messages between user members over the electronic network.

17. A method of venue evaluation, comprising:
providing to a member user in real-time, over an electronic network, a venue information,
wherein the venue information includes both a real-time subjective critical review of the venue including ambiance factors comprised of a subjective review of the nonmember patrons attending the venue, and
the real-time demographical analysis includes statistical information regarding the demographic makeup of member users attending the venue;
providing an encyclopedic database editable by users evaluating the venue; and
graphically displaying venue and user locations as location coordinates on a map.

18. The method of claim 17, further including the user member providing a set of desired demographic criteria by which to further evaluate the venue based upon user members attending a venue matching the desired demographic criteria.

19. The method of claim 17, further including assembling a user alert list, wherein the user alert list comprises a list of user members having a select member demographic profile of compatibility and notifying the user member over a network if another user within the user alert list is in close physical proximity.

20. The method of claim 17, further including evaluating the venue by the user members who have registered an intention of attending the venue.

21. The method of claim 17, further including a highlighted portion graphically represented on the map, wherein the highlighted portion represents a collection of venues whose respective coordinates on the map fall within the highlighted portion of the map.

22. The method of claim 21, wherein the highlighted portion comprises a glow of varying intensity, wherein increasing interest levels in a highlighted portion are represented by increasing intensities of glow.
